(19) United States
(12) Patent Application Publication
(10) Pub. No.: US 2025/0316708 A1
(43) Pub. Date: Oct. 9, 2025

(54) CURRENT COLLECTOR HAVING MULTIPLE LAYERS OF STRUCTURES AND PREPARATION METHOD THEREFOR

(71) Applicant: YANGZHOU NANOPORE INNOVATIVE MATERIALS TECHNOLOGY LTD, Yangzhou (CN)

(72) Inventors: Chenghao WANG, Yangzhou (CN); Xuefa LI, Yangzhou (CN); Guoping ZHANG, Yangzhou (CN)

(21) Appl. No.: 18/864,922

(22) PCT Filed: May 15, 2023
(86) PCT No.: PCT/CN2023/094198

§ 371 Date: Nov. 12, 2024

(30) Foreign Application Priority Data
May 13, 2022 (CN) 202210521195.9
Jun. 2, 2022 (WO) PCT/CN2022/096782

(51) Int. Cl. H01M 4/66; H01M 4/02; H01M 4/04

(52) U.S. Cl. CPC H01M 4/667; H01M 4/0423; H01M 4/661; H01M 4/663; H01M 4/668; H01M 2004/021

(57) ABSTRACT

The present invention relates to a current collector having multiple layers of structures and a preparation method therefor. The current collector having the multiple layers of structures comprises a polymer film layer, wherein two surfaces of the polymer film layer that face away from each other are respectively provided with stacked layers, and each stacked layer comprises carbon coatings and metal coatings, which are alternately laminated.

### TECHNICAL FIELD

The present application relates to the technical field of secondary batteries, and in particular to a multilayer current collector and a preparation method therefor.

### BACKGROUND

Currently, the current collectors are mainly copper current collectors and aluminum current collectors, wherein the copper current collector or aluminum current collector is composed of two parts, comprising a polymer film layer in the middle and metal depositing layers on the two opposite surfaces of the polymer film layer. The preparation of current collector is completed through the vacuum evaporation process; because of the current evaporation process, the initial thickness of the depositing layer is within 32-500 nm, but with the increase of the number of metal depositing layers, the increment of the thickness of the following metal depositing layer becomes smaller and smaller. To reach the desired number of layers, the polymer film layer may be required to be continuously subjected to vapor deposition for 15-20 times to reach the required thickness, and the metal depositing layer will have lots of pores in the interior after the repeated evaporation, resulting in the porosity of the metal depositing layer of up to 30%. The existence of these pores reduces the current-passing area of the metal depositing layer and affects the electron transport, resulting in a large sheet resistance inside the metal depositing layer, increasing the polarization of the battery, and seriously affecting the battery performance. Meanwhile, after evaporation for many times, the middle polymer film layer undergoes cooling and heating for dozens of times, which leads to a rapid attenuation of the mechanical properties of the polymer film layer, thus leading to a large attenuation of the tensile strength and elongation of the multilayer current collector.

### SUMMARY

Based on this, the present application provides a multilayer current collector and a preparation method therefor which can reduce the number of times of evaporation of the metal depositing layer and the polymer film layer to reduce the attenuation of the mechanical properties of the polymer film layer, effectively ensure the performance of the battery, and effectively improve the mechanical properties and electrical conductivity of the product.

The present application provides a multilayer current collector, and the multilayer current collector comprises:

a polymer film layer, a stacked layer is arranged on two opposite surfaces of the polymer film layer, and the stacked layer comprises carbon coating layer(s) and metal depositing layer(s) which are stacked alternately, wherein the outermost layer and the innermost layer of the stacked layer both are the carbon coating layers, and a thickness ratio of each carbon coating layer to its adjacent metal depositing layer is 3:1-2:1.

In some embodiments, the stacked layer comprises two or more carbon coating layers, wherein the thicknesses of any two carbon coating layers can be identical or different.

In some embodiments, the stacked layer comprises one or more metal depositing layers. In some embodiments, the stacked layer comprises two or more metal depositing layers, wherein the thicknesses of any two metal depositing layers can be identical or different.

In some embodiments, the carbon coating layer comprises at least one selected from carbon black, carbon nanotubes, graphite, acetylene black, and graphene.

In some embodiments, the metal depositing layer is an aluminum metal layer or a copper metal layer.

In some embodiments, both the metal depositing layer and the carbon coating layer have a purity of ≥99.8%

In some embodiments, the polymer film layer comprises at least one selected from an insulating polymer material, an insulating polymer composite material, a conductive polymer material, and a conductive polymer composite material.

In some embodiments, the polymer film layer has a thickness of 1-25 μm, any one of the metal depositing layer has a thickness ranging from 50 nm to 130 nm, and any one of the carbon coating layer has a thickness ranging from 150 nm to 260 nm.

The present application also provides a preparation method for the multilayer current collector as described above, which comprises the following steps:
arranging the carbon coating layer and the metal depositing layer alternately on two opposite surfaces of the polymer film layer to form the stacked layer;
wherein the outermost layer and the innermost layer of the stacked layer both are the carbon coating layers.

In some embodiments, the innermost carbon coating layer is in direct contact with the surface of the polymer film layer.

In some embodiments, the carbon coating layer is arranged on two opposite surfaces of the polymer film layer and on the surface of the metal depositing layer by sputtering.

In some embodiments, the carbon coating layer is arranged on two opposite surfaces of the polymer film layer and on the surface of the metal depositing layer by evaporation.

In some embodiments, during vacuum evaporation, the metal depositing layer is evaporated at an evaporation temperature ranging from 500° C. to 900° C.; the carbon coating layer is evaporated at an evaporation temperature ranging from 900° C. to 1200° C.

In the above solution, a stacked layer is arranged on two opposite surfaces of the polymer film layer, and a thickness ratio of each carbon coating layer to its adjacent metal depositing layer is 3:1-2:1, which can effectively reduce the number of times of evaporation of the metal depositing layer and the polymer film layer, thereby effectively reducing the porosity and sheet resistance of the product and effectively ensuring the battery performance. The attenuation of the mechanical properties of the polymer film layer can be reduced, thus reducing the attenuation of the mechanical properties of the product. Meanwhile, because the carbon coating layer has excellent electrical conductivity, mechanical properties, and high chemical stability, the mechanical properties, electrical conductivity, and corrosion resistance of the product can be effectively improved. The carbon coating layer is arranged on two opposite surfaces of the polymer film layer to protect the polymer film layer; the outermost layer of the stacked layer is the carbon coating layer, which can effectively reduce the interfacial resistance between the multilayer current collector and the active substance, and effectively improve the adhesive force.

### BRIEF DESCRIPTION OF DRAWINGS

The drawings which form part of the present application are used to provide a further understanding of the present application, and the illustrative examples of the present application and the description thereof are used to explain the present application and do not constitute an undue limitation of the present application.

In order to more clearly illustrate the technical solutions in examples of the present application, the drawings used in the description of the examples will be briefly described below. Apparently, the drawings in the following description are only some examples of the present application, and those skilled in the art may obtain other drawings based on these drawings without creative efforts.

FIG. 1 shows a structural schematic diagram of a multilayer current collector shown in an example of the present application.

Reference list: 10—multilayer current collector; 100—polymer film layer; 200—carbon coating layer; and 300—metal depositing layer

### DETAILED DESCRIPTION

In order to facilitate a clear understanding of the above objects, features and advantages of the present application, a detailed description of the specific embodiments of the present application is provided below with reference to the drawings. In the following description, many specific details are described to facilitate a full understanding of the present application. However, the present application can be implemented in many other ways different from those described herein, and those skilled in the art can make similar improvements without departing from the content of the present application. Therefore, the present application is not limited by the specific embodiments disclosed below.

In the description of the present application, it should be understood that the orientation or position relationship indicated by terms, for example, “center”, “longitudinal”, “lateral”, “length”, “width”, “thickness”, “up”, “down”, “front”, “back”, “left”, “right”, “vertical”, “horizontal”, “top”, “bottom”, “inside”, “outside”, “clockwise”, “anticlockwise”, “axial”, “radial”, “circumferential”, etc., is based on the orientation or position relationship shown in the drawings, which is only intended to facilitate the description of the present application and simplify the description, not to indicate or imply that the device or element referred to must have a particular orientation or must be constructed and operated in a specific orientation, and therefore cannot be understood as a limitation of the present application.

In addition, terms such as “first” and “second” are used only for descriptive purposes and cannot be understood as indicating or implying relative importance or implicitly specifying the number of technical features referred to. Thus, features defined by “first” and “second” can explicitly or implicitly comprise at least one of the features. In the description of the present application, unless otherwise expressly specified, “a plurality of” means at least two, such as two, three, etc.

In the present application, unless otherwise expressly specified and limited, the terms such as “arrange”, “connect”, “attach”, and “fixing” are to be understood in a broad sense, for example, as a fixed connection, or as a detachable connection, or as an integrated connection; as a mechanical connection, or as an electrical connection; as a direct connection, or as an indirect connection via an intermediate medium; or as a communication between two elements, or as an interaction between two elements. Unless otherwise expressly specified, for those skilled in the field, the specific meaning of the above terms can be understood in the light of specific context in the present application.

In the present application, unless otherwise expressly specified and limited, the first feature being “above” or “below” the second feature can be the first feature and the second feature being in direct contact, or the first feature and the second feature being in indirect contact through an intermediate medium. Furthermore, the first feature being “above”, “over” and “on” the second feature can mean that the first feature is directly above or diagonally above the second feature, or only mean that the level of the first feature is higher than that of the second feature. The first feature being “below”, “under”, and “underneath” the second feature can mean that the first feature is directly below or diagonally below the second feature, or only mean that the level of the first feature is lower than that of the second feature.

It should be noted that in a case where an element is described as being “fixed in” or “set in” another element, it can contact with the other element directly or there can be an intermediate element. In a case where an element is considered to be “connected” to another element, it can be connected to the other element directly or there can be an intermediate element as well. The terms “vertical”, “horizontal”, “up”, “down”, “left”, “right”, and similar expressions used herein are intended for illustrative purposes only and are not meant to be the only implementation.

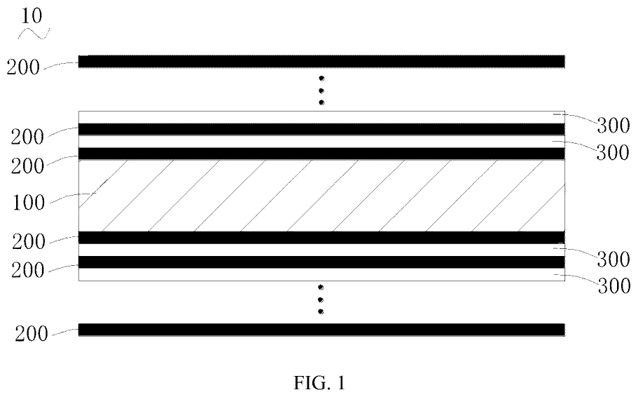

Referring to FIG. 1, an example in the present application provides a multilayer current collector 10, and the multilayer current collector comprises a polymer film layer 100, and a stacked layer is arranged on two opposite surfaces of the polymer film layer 100, and the stacked layer comprises a carbon coating layer 200 and a metal depositing layer 300 which are stacked alternately. Specifically, the outermost layer and the innermost layer of the stacked layer both are carbon coating layers 200. The carbon coating layer 200 is arranged on two opposite surfaces of the polymer film layer 100, which can protect the polymer film layer 100; the outermost layer of the stacked layer is the carbon coating layer 200, which can effectively reduce the interfacial resistance between the multilayer current collector 10 and the active substance, and effectively improve the adhesive force.

Specifically, a thickness ratio of each carbon coating layer 200 to its adjacent metal depositing layer 300 is 3:1-2:1.

The carbon coating layer 200 and the metal depositing layer 300 are alternately arranged on the two opposite surfaces of the polymer film layer 100, and the thickness ratio of each carbon coating layer 200 to its adjacent metal depositing layer 300 is 3:1-2:1, so that the number of times of evaporating the metal depositing layer 300 can be effectively reduced, thereby reducing the pores inside the metal depositing layer 300, which can effectively reduce the porosity and sheet resistance inside the metal depositing layer 300, and further reduce the porosity and sheet resistance of the products and effectively guarantee the battery performance. Meanwhile, it can effectively reduce the number of times of evaporating the polymer film layer 100, and can reduce the attenuation of the mechanical properties of the polymer film layer 100, thereby reducing the attenuation of the mechanical properties of the product. Because the carbon coating layer 200 has excellent electrical conductivity, mechanical properties, and high chemical stability, the mechanical properties, electrical conductivity, and corrosion resistance of the product can be effectively improved.

The multilayer current collector 10 has a puncture strength of ≥50 gf, a Machine Direction (MD) tensile strength of ≥150 MPa, a Transverse Direction (TD) tensile strength of ≥150 MPa, an MD elongation of ≥10%, and a TD elongation of ≥10%. For example, the multilayer current collector 10 has a puncture strength of 80 gf, an MD tensile strength of 280 MPa, a TD tensile strength of 280 MPa, an MD elongation of 60%, and a TD elongation of 60%. It should be noted that MD (Machine Direction) refers to the longitudinal direction, and TD (Transverse Direction, perpendicular to the machine direction) refers to the transverse direction.

Referring to FIG. 1, according to some embodiments of the present application, optionally, the carbon coating layer 200 comprises at least one selected from carbon black, carbon nanotubes, graphite, acetylene black, and graphene. Specifically, the carbon black has excellent electrical conductivity, mechanical properties, and thermal conductivity. The carbon nanotubes have good mechanical properties, high electrical conductivity, and high thermal conductivity. The graphite has good mechanical properties, high temperature resistance, high electrical conductivity, good thermal conductivity, high chemical stability, thermal shock resistance, and plasticity. The acetylene black has good mechanical properties, very low resistivity, excellent electrical conductivity, thermal conductivity, and anti-static effect. The graphene has excellent electrical conductivity and very good thermal conductivity.

Referring to FIG. 1, according to some embodiments of the present application, optionally, the metal depositing layer 300 is an aluminum metal layer or a copper metal layer. Specifically, the metal layer 300 has a purity of ≥99.8%, that is, the metal layer 300 in the present application employs a high-purity metal. In one embodiment, the metal layer is an aluminum metal layer, and the aluminum metal layer has a purity of ≥99.8%. The high-purity aluminum metal has properties such as low deformation resistance, high electrical conductivity, and good plasticity. In another embodiment, the metal layer is a copper metal layer, and the copper metal layer has a purity of ≥99.8%. The high-purity copper metal has good ductility, heat transfer properties, and electrical conductivity.

Referring to FIG. 1, according to some embodiments of the present application, optionally, the carbon coating layer 200 has a purity of ≥99.8%. The high-purity carbon coating layer 200 has high mechanical properties, high chemical stability, high electrical conductivity, dense and uniform structure, good wear resistance, and low resistance coefficient.

A peeling force between the carbon coating layer 200 and the polymer film layer 100 is ≥3 N/m. For example, the peeling force between the carbon coating layer 200 and the polymer film layer 100 is 5 N/m. The peeling force between the carbon coating layer 200 and the polymer film layer 100 is high, so that the peeling force between the carbon coating layer 200 and the polymer film layer 100 can be strengthened, thereby avoiding the peeling of the carbon coating layer 200 and the polymer film layer 100 so as to ensure the electrical performance and safety of the battery.

Referring to FIG. 1, according to some embodiments of the present application, optionally, the polymer film layer 100 comprises at least one selected from an insulating polymer material, an insulating polymer composite material, a conductive polymer material, and a conductive polymer composite material. The polymer film layer 100 has a puncture strength of ≥100 gf, an MD tensile strength of ≥200 MPa, and a TD tensile strength of ≥200 MPa, an MD elongation of ≥30%, and a TD elongation of ≥30%. For example, the polymer film layer 100 has a puncture strength of 180 gf, an MD tensile strength of 500 MPa, a TD tensile strength of 500 MPa, an MD elongation of 130%, and a TD elongation of 130%.

Specifically, the insulating polymer material comprises at least one selected from polyamide (PA), polyterephthalate, polyimide (PI), polyethylene (PE), polypropylene (PP), polystyrene (PPE), polyvinyl chloride (PVC), aramid, an acrylonitrile-butadiene-styrene copolymer (ABS), polybutylene terephthalate (PET), poly(p-phenylene terephthamide) (PPTA), polypropylene ethylene (PPE), polyoxymethylene (POM), an epoxy resin, a phenolic resin, polytetrafluoroethylene (PTEE), polyvinylidene fluoride (PVDF), a silicone rubber, polycarbonate (PC), polyvinyl alcohol (PVA), polyethylene glycol (PEG), cellulose, starch, a protein, derivatives thereof, cross linked polymers thereof, and copolymers thereof.

The above insulating polymer composite material can be a composite material formed from the insulating polymer material and the inorganic material, wherein the inorganic material can be at least one selected from a ceramic material, a glass material, and a ceramic composite material.

The above conductive polymer material can be at least one selected from doped poly(sulfur nitride) and doped polyacetylene.

The above conductive polymer composite material can be a composite material formed from an insulating polymer material and a conductive material. Specifically, the conductive material may be at least one selected from a conductive carbon material, an metal material, and a composite conductive material. More specifically, the conductive carbon material is selected from at least one selected from carbon black, carbon nanotubes, graphite, acetylene black, and graphene. The metal material is selected from at least one selected from nickel, iron, copper, aluminum, and an alloy of the above metals. The composite conductive material is at least one selected from nickel-coated graphite powder and a nickel-coated carbon fiber.

Referring to FIG. 1, according to some embodiments of the present application, optionally, the polymer film layer 100 has a thickness ranging from 1 μm to 25 μm, the metal depositing layer 300 has a thickness ranging from 32 nm to 500 nm, and the carbon coating layer 200 has a thickness ranging from 140 nm to 1000 nm. Preferably, the metal depositing layer 300 has a thickness ranging from 50 nm to 130 nm; the carbon coating layer 200 has a thickness ranging from 150 nm to 260 nm. It should be understood that a thickness of the multilayer current collector 10 of the present application ranges from 3 μm to 30 μm. For example, the thickness of the polymer film layer 100 is 20 μm, the thickness of any of the metal depositing layer 300 is 60 nm, and the thickness of any of the carbon coating layer 200 is 160 nm.

### EXAMPLE

The following examples more specifically describe the disclosure of the present application, and these embodiments are intended for an illustrative purpose only. Various modifications and variations within the disclosure of the present application will be obvious to those skilled in the art. Unless otherwise stated, all parts, percentages, and ratios described in the following Examples are based on weight, and all reagents used in the Examples are commercially available or synthesized with conventional methods and can be used directly without further processing. The instruments used in the examples are commercially available.

### Example 1

An example in the present application provides a preparation method for the above multilayer current collector 10, which comprises the following steps.

Step 1: A 6 μm polymer film layer 100, an aluminum metal layer with a purity of 99.9% and graphite with a purity of 99.9% were selected, wherein the polymer film layer 100 was made of polybutylene terephthalate (PET).

Step 2: Graphite with a purity of 99.9% and the aluminum metal layer with a purity of 99.9% were alternately deposited on two opposite surfaces of the polymer film layer 100 until a set thickness was reached to form a stacked layer.

The outermost layer and innermost layer of the stacked layer both were carbon coating layers 200, i.e., the graphite was deposited on the two opposite surfaces of the polymer film layer 100, and the outermost layer of the stacked layer was graphite. The thickness was set at 8 μm. There were two aluminum metal layers and three graphite layers, i.e., in this example, each metal depositing layer 300 had a thickness of 125 nm, and each carbon coating layer 200 had a thickness of 250 nm. It should be understood that because of the 2 aluminum metal layers and the 3 graphite layers, 10 layers in total were required to be deposited on the polymer film layer 100 to obtain an 8 μm multilayer current collector 10, i.e., the polymer film layer 100 was subjected to the evaporation process for 10 times; after the evaporation of the innermost carbon coating layer 200 on the two opposite surfaces of the polymer film layer was completed, it was still necessary to deposit 8 layers of structure to form the complete multilayer current collector 10, i.e., after the innermost carbon coating layer 200 in contact with the polymer film layer 100 was prepared, the evaporation still needed to be performed for 8 more times; after the evaporation of the metal depositing layer 300 near the polymer film layer 100 was completed, it was necessary to deposit 6 layers of structure to form the complete multilayer current collector 10, i.e., after the metal depositing layer 300 near the polymer film layer 100 was prepared, the evaporation needed to be performed for 6 more times; the metal depositing layer 300 and the carbon coating layer 200 were deposited repeatedly and sequentially until the two depositions of the outermost carbon coating layer 200 had been completed to form the complete multilayer current collector 10.

After the multilayer current collector 10 was prepared, the multilayer current collector 10 was subjected to slitting and winding as well as a vacuum packaging operation. Specifically, in this example, an unwinding tension was 10 N, and an unwinding tension was 8 N.

Referring to FIG. 1, according to some embodiments of the present application, optionally, the metal depositing layer 300 is deposited at an evaporation temperature ranging from 500° C. to 900° C., and the carbon coating layer 200 is deposited at an evaporation temperature ranging from 900° C. to 1200° C. For example, the metal depositing layer 300 is deposited at an evaporation temperature of 850° C., and the carbon coating layer 200 is deposited at an evaporation temperature of 1000° C. In a case where the graphite with a purity of 99.9% and the aluminum metal layer with a purity of 99.9% are alternately deposited on the two opposite surfaces of the polymer film layer 100, the vacuum degree is 0.05 Pa. In a case where the graphite with a purity of 99.9% and the aluminum metal layer with a purity of 99.9% are alternately deposited on the two opposite surfaces of the polymer film layer 100, the evaporation speed is 100 m/min.

Referring to FIG. 1, according to some embodiments of the present application, optionally, the carbon coating layer 200 is arranged on two opposite surfaces of the polymer film layer 100 and on the surface of the metal depositing layer 300 by sputtering.

### Example 2

This example differs from Example 1 in that the polymer film layer 100 has a thickness of 25 μm. The aluminum metal layer had 1 layer, and the graphite had 2 layers, that is, in this example, the thickness of each metal depositing layer 300 was 500 nm, and the thickness of each carbon coating layer 200 was 1000 nm. The 30 μm multilayer current collector 10 was finally prepared.

### Example 3

This example differs from Example 1 in that each metal depositing layer 300 had a thickness of 125 nm, and each carbon coating layer 200 had a thickness of 375 nm. Thus, the multilayer current collector 10 had a thickness of 8.75 μm.

### Comparative Example 1

This Comparative Example 1 provides a preparation method for a multilayer current collector 10, which comprises the following steps:

Step 1: A 6 μm polymer film layer 100, and an aluminum metal layer with a purity of 99.9% were selected, wherein the polymer film layer 100 was made of polybutylene terephthalate (PET).

Step 2: An aluminum metal layer with a purity of 99.9% was deposited on two opposite surfaces of the polymer film layer 100. The process of evaporating the aluminum metal layer on the two opposite surfaces of the polymer film layer 100 was a suspended multiple vacuum evaporation process. In this example, the thickness of the aluminum metal layer was 125 nm, and the aluminum metal layer had 8 layers. It should be understood that because the thickness of a single aluminum metal layer was 125 nm, the polymer film layer 100 was required to be continuously subjected to vapor deposition for 16 times to prepare the multilayer current collector 10 with a thickness of 8 μm.

After the multilayer current collector 10 was prepared, the multilayer current collector 10 was subjected to slitting and winding as well as a vacuum packaging operation.

### Comparative Example 2

This comparative example differs from Example 1 in that the polymer film layer 100 had a thickness of 25 μm. The aluminum metal layer had 5 layers. In this example, a thickness of the metal depositing layer 300 was 500 nm. The 30 μm multilayer current collector was finally prepared. In this example, the polymer film layer 100 was required to be continuously subjected to vapor deposition for 10 times.

### Comparative Example 3

This comparative example differs from Example 1 in that the innermost layer of the stacked layer was the metal depositing layer 300, the outermost layer was the carbon coating layer 200, and the metal depositing layer 300 and the carbon coating layer 200 both had 2 layers, each metal depositing layer 300 had a thickness of 125 nm, and each carbon coating layer 200 had a thickness of 250 nm. Thus, the multilayer current collector had a thickness of 7.5 μm.

### Comparative Example 4

This comparative example differs from Example 1 in that the outermost layer of the stacked layer was the metal depositing layer 300, the innermost layer was the carbon coating layer 200, and the metal depositing layer 300 and the carbon coating layer 200 both had 2 layers, each metal depositing layer 300 had a thickness of 125 nm, and each carbon coating layer 200 had a thickness of 250 nm. Thus, the multilayer current collector 10 had a thickness of 7.5 μm.

### Comparative Example 5

This comparative example differs from Example 1 in that the thickness of each carbon coating layer was 200 μm. Thus, the thickness of the current collector was 7.7 μm.

### Comparative Example 6

This comparative example differs from Example 1 in that the thickness of each carbon coating layer was 400 μm. Thus, the thickness of the current collector was 8.9 μm.

The porosity of the multilayer current collectors 10 in Examples 1-3 and Comparative Examples 1-2 were tested, and the obtained data are shown in Table 1. The test method of the porosity was as follows: the sample of the multilayer current collector was cleaned, and the pre-treated film sample was put into a pore adsorption instrument, so that the gas was adsorbed in the pore of the film to reach the equilibrium. The specific surface area and pore size distribution of the film were calculated from the isotherms of the adsorbent, and the porosity of the film was analyzed from the data provided by the instrument. Table 1 shows the porosity test data of the multilayer current collector 10.

TABLE 1

| Solution | Porosity (%) |
|---|---|
| Example 1 | 20 |
| Example 2 | 15 |
| Example 3 | 22 |
| Comparative Example 1 | 28 |
| Comparative Example 2 | 26 |

As can be seen from the above table, the porosity of the multilayer current collector 10 of the present application was lower than that in comparative examples. As can be seen from Table 1, the fewer times of evaporation of the metal depositing layer 300, the lower the porosity of the multilayer current collector 10. The multilayer current collector 10 of the present application could increase the current-passing area of metal depositing layer 300, and did not affect the electron transport.

The sheet resistance of the multilayer current collectors 10 in Examples 1-3 and Comparative Examples 1-2 were tested, and the obtained data are shown in Table 2. The test method of the sheet resistance of the multilayer current collector 10 was as follows: a sample of the current collector with a length and width of about 200 mm was cut and the sheet resistance of the sample was tested by a sheet resistance meter.

Table 2 shows test data of the sheet resistance of the multilayer current collector 10.

TABLE 2

| Solution | Sheet resistance (Ω/port) |
|---|---|
| Example 1 | 30 |
| Example 2 | 25 |
| Example 3 | 32 |
| Comparative Example 1 | 35 |
| Comparative Example 2 | 33 |

From the above table, it can be seen that the sheet resistance of the multilayer current collector 10 of the present application was lower than that in comparative examples. As can be seen from Table 2, the fewer times of evaporation of the metal depositing layer 300, the lower the sheet resistance of the multilayer current collector 10. The multilayer current collector 10 of the present application had low sheet resistance, which can reduce the polarization of the battery and effectively ensure the battery performance.

The tensile strength, elongation, and puncture strength of the multilayer current collectors 10 in Examples 1-3 and Comparative Examples 1-2 were tested, and the obtained effect data is shown in Table 3.

The test method of the tensile strength and elongation of the multilayer current collector 10 was as follows. One end of the multilayer current collector was clamped in the upper gripper of the tensile tester and the other end was clamped in the lower gripper of the tensile tester and held in the same axis; the specification, speed, and unit of the test machine were set, and the elongation and load value of the samples were tested and recorded during the test process; the tensile strength and elongation of the multilayer current collector were calculated from the test results.

The test method of the puncture strength of the multilayer current collector 10 was as follows. The multilayer current collector was cut into rectangular with a fixed size as a sample. The sample was clamped to a puncture table to ensure a flat surface of the sample. A circular probe (with a diameter of round tip of 3.0 mm) was used to apply pressure to the sample at a rate of 1 mm/s until a specified peak pressure was reached or the sample punctures. Generally, the peak pressure was 50 N and the penetration depth was 25 mm. The maximum force applied by the probe was recorded at each puncture point. The puncture strength of the sample was calculated by analyzing the test data.

Table 3 shows the test data of the tensile strength, elongation, and puncture strength of the multilayer current collector 10.

TABLE 3

| | | | | Compar- | Compar- |
|---|---|---|---|---|---|
| | | | | ative | ative |
| | Example 1 | Example 2 | Example 3 | Example 1 | Example 2 |
| MD tensile | 310 | 280 | 305 | 220 | 200 |
| strength | | | | | |
| (MPa) | | | | | |
| TD tensile | 280 | 250 | 270 | 200 | 180 |
| strength | | | | | |
| (MPa) | | | | | |
| MD | 60 | 47 | 58 | 43 | 33 |
| elongation | | | | | |
| (%) | | | | | |
| TD | 47 | 34 | 43 | 33 | 23 |
| elongation | | | | | |
| (%) | | | | | |
| Puncture | 320 | 300 | 305 | 260 | 240 |
| strength | | | | | |
| (gf) | | | | | |

From the above table, it can be seen that the tensile strength, elongation, and puncture strength of the multilayer current collector 10 of the present application were higher than those in comparative examples. As can be seen from Table 2, the fewer the times of evaporation of the polymer film layer 100, the higher the tensile strength, elongation, and puncture strength of the multilayer current collector 10. The mechanical properties and electrical conductivity of the multilayer current collector 10 of the present application were greatly improved compared with those in the comparative examples.

The change rate of sheet resistance after tension, peeling force, peeling force after electrolyte corrosion, change rate of peeling force, and elastic modulus of the multilayer current collectors 10 in Example 1 and Comparative Examples 3-6 were tested, and the obtained data are shown in Table 4.

The test method of the change rate of the sheet resistance after tension was as follows. The sheet resistance “a” of the current collector before tension was tested by a sheet resistance meter, the sheet resistance “b” of the current collector after tension to 2% was tested by a sheet resistance meter, and the change rate of the sheet resistance after tension=(b−a)/a.

The test method of peeling force without corrosion was as follows. A tape with a length of 11 cm was pasted on a steel plate, and a current collector with a length of 10 cm was pasted on the tape; a tape with a length of 22 cm was pasted on the current collector, and the steel plate was fixed to a peeling force tester; the tape with a length of 22 cm was bent into a U-shape, then the free end of the tape with a length of 22 cm was clamped by the gripper of the peeling force tester, and then the peeling force tester was started, and the peeling force “c” was tested by pulling the tape to separate the depositing layer from the polymer film layer.

The test method of peeling force after electrolyte corrosion was as follows. A tape with a length of 11 cm was pasted on a steel plate, and a current collector with a length of 10 cm which had been soaked in the electrolyte for 24 h was pasted on the tape; a tape with a length of 22 cm was pasted on the current collector, and the steel plate was fixed to the peeling force tester; the tape with a length of 22 cm was bent into a U-shape, then the free end of the tape with a length of 22 cm was clamped by the gripper of the peeling force tester, and then the peeling force tester was started, and the peeling force “d” was measured by pulling the tape to separate the depositing layer from the polymer film layer.

$$The change rate of peeling force after corrosion = ( c - d ) / c .$$

Table 4 shows the change rate of sheet resistance after tension, peeling force before corrosion, peeling force after corrosion, change rate of peeling force after corrosion, and elastic modulus of the multilayer current collector 10.

TABLE 4

| | Change rate | | Peeling | Change | |
|---|---|---|---|---|---|
| | of sheet | Peeling | force after | rate of | Elastic |
| | resistance | force | corrosion | peeling | modulus |
| | after tension | (N/m) | (N/m) | force | (MPa) |
| Example 1 | 0.27 | 920 | 510 | 0.446 | 12800 |
| Comparative | 0.35 | 910 | 390 | 0.571 | 12300 |
| Example 3 | | | | | |
| Comparative | 0.33 | 825 | 430 | 0.479 | 12400 |
| Example 4 | | | | | |
| Comparative | 0.29 | 922 | 508 | 0.449− | 14500 |
| Example 5 | | | | | |
| Comparative | 0.25 | 822 | 460 | 0.440− | 12700 |
| Example 6 | | | | | |

As can be seen from the above table, according to the comparison of Example 1 and Comparative Example 3, compared with only the outermost layer being the carbon coating layer, the innermost layer and outermost layer which were both carbon coating layers had less change in peeling force after electrolyte corrosion, and the current collector was more resistant to the electrolyte corrosion when applied to the battery.

According to the comparison of Example 1 and Comparative Example 4, compared with only the innermost layer being the carbon coating layer, the innermost layer and outermost layer which were both carbon coating layers had a smaller change rate of sheet resistance after tension. During the preparation of the battery, the current collector will be subjected to tension, and the metal depositing layer would easily have small cracks during the tension process, which would affect the sheet resistance. However, the carbon coating layer located in the outermost layer was not easily broken during the tension process, which could still ensure the current flowed between the current collector and the active material coated on the current collector, and the carbon coating layer which was not easy to be deformed will reduce the size of the cracks of the metal depositing layer, further avoiding the increase of the sheet resistance. Therefore, the current collector of the present application has little effect caused by tension on the electrical performance of the battery after being applied to the battery.

According to the comparison of Example 1 and Comparative Examples 5 and 6, in a case where the thickness ratio of the carbon coating layer to the metal depositing layer was more than 3, the peeling force between the carbon coating layer and the polymer film layer was reduced; in a case where the thickness ratio of the carbon coating layer to the metal depositing layer was less than 2, the elasticity modulus of the current collector was increased, and the current collector was not easy to be deformed, which would increase the difficulty of the subsequent winding.

The technical features of the above examples can be combined in any manner, and for the reason of brief description, not all possible combinations of the technical features of the above examples have been described, However, as long as there is no contradiction in the combinations of these technical features, they should be considered to fall within the scope of this specification.

The above examples only illustrate several embodiments of the present application which are described in details, but they are not regarded as a limitation of the protection scope of the present application. It should be noted that those skilled in the art may make various modifications and improvements without departing from the conception of the present application, which are within the protection scope of the present application. Therefore, the protection scope of the present application shall be subject to the contents of the claims.

1. A multilayer current collector, which comprises:
a polymer film layer, and
a stacked layer that is arranged on two opposite surfaces of the polymer film layer,
wherein the stacked layer comprises one or more carbon coating layers and one or more metal depositing layers that are stacked alternately, wherein an outermost layer and an innermost layer of the stacked layer both are the carbon coating layers, and a thickness ratio of each carbon coating layer to its adjacent metal depositing layer is 3:1-2:1.

2. The multilayer current collector according to claim 1, wherein the carbon coating layer comprises at least one selected from carbon black, carbon nanotubes, graphite, acetylene black, and graphene.

3. The multilayer current collector according to claim 1, wherein the metal depositing layer is an aluminum metal layer or a copper metal layer.

4. The multilayer current collector according to claim 1, wherein both the metal depositing layer and the carbon coating layer have a purity of ≥ 99.8%.

5. The multilayer current collector according to claim 1, wherein the polymer film layer comprises at least one selected from an insulating polymer material, an insulating polymer composite material, a conductive polymer material, and a conductive polymer composite material.

6. The multilayer current collector according to claim 1, wherein the polymer film layer has a thickness ranging from 1 μm to 25 μm, the metal depositing layer has a thickness ranging from 50 nm to 130 nm, and the carbon coating layer has a thickness ranging from 150 nm to 260 nm.

7. A preparation method for the multilayer current collector according to claim 1, which comprises the following steps:
arranging the carbon coating layer and the metal depositing layer alternately on two opposite surfaces of the polymer film layer to form the stacked layer;
wherein the outermost layer and the innermost layer of the stacked layer both are the carbon coating layers.

8. The preparation method for the multilayer current collector according to claim 7, wherein the carbon coating layer is arranged onto two opposite surfaces of the polymer film layer and onto the surface of the metal depositing layer by sputtering.

9. The preparation method for the multilayer current collector according to claim 7, wherein the carbon coating layer is arranged onto two opposite surfaces of the polymer film layer and onto the surface of the metal depositing layer by evaporation.

10. The preparation method for the multilayer current collector according to claim 9, wherein the metal depositing layer is evaporated at an evaporation temperature ranging from 500° C. to 900° C.; the carbon coating layer is evaporated at an evaporation temperature ranging from 900° C. to 1200° C.
